(19) United States
(12) Patent Application Publication
(10) Pub. No.: US 2002/0023595 A1
(43) Pub. Date: Feb. 28, 2002

(54) Leash

(76) Inventor: Helene Kaufman, New York, NY (US)

Correspondence Address: LADAS & PARRY, 26 WEST 61ST STREET, NEW YORK, NY, 10023, US

(21) Appl. No.: 09/849,287

(22) Filed: May 4, 2001

Related U.S. Application Data
(60) Provisional application No. 60/226,519, filed on Aug. 21, 2000.

(51) Int. Cl. A01K 27/00

(52) U.S. Cl. 119/797

(57) ABSTRACT

A leash has an elongated and flexible arrangement for defining first and second longitudinally opposite ends, whereby the first end can be connected to a movable object and the second end can be used as a handgrip. A handgrip arrangement is intermediate the ends for defining a handgrip, whereby to define a first segment of the elongated and flexible arrangement between the first end and the handgrip arrangement. Another arrangement adjusts a length of the first segment between the first end and the handgrip arrangement.

### BACKGROUND OF THE INVENTION

My invention relates to a leash which, a used herein, is equivalent to a lead, rein or other elongated flexible structures for connecting an object to a mobile object

Although the leash is described in relation to a dog leash, it will be appreciated by those of ordinary skill that the invention also has utility in other applications, for example with people, children, cats, horses and the like. A particular utility is in allowing dogs to visit children, for example for therapy in children's hospitals or institutions where the dogs' owners retain control of the dogs via longer leash segments and the children interact with the dogs via shorter leash segments. Another particular utility is in dog training, wherein the trainer has the option of longer, looser control or shorter, closer control.

Culp U.S. Pat. No. 6,649,504 of Jul. 22, 1997, is incorporated herein by reference.

### SUMMARY OF THE INVENTION

An object of my invention is improvements over the disclosure of the Culp patent.

For example, a dog-end, usually shorter leash segment (close control lead of the Culp patent) has an adjustable length between its ends (second handle and second releasable connector of the Culp patent). The adjustability is important to adapt the leash to different users, e.g., for interactions of children of different heights, and uses, e.g., training a dog for sitting and lying down, heeling or restraining an unruly dog.

For another example, the handgrips (handles of the Culp patent) of the leash segments of my invention need not be loops or handles as in the Culp patent. Mere marking to show the location of the handgrip of the dog-end leash segment and an end of the other, usually longer leash segment are sufficient, particularly if the leash segments are permanently joined, as in a preferred embodiment of my invention.

In a preferred embodiment, my invention is a leash having an elongated and flexible arrangement for defining first and second longitudinally opposite ends, whereby the first end can be connected to a movable object and the second end can be used as a handgrip. A handgrip arrangement is intermediate the ends for defining a handgrip, whereby to define a first segment of the elongated arrangement between the first end and the handgrip arrangement. Another arrangement adjusts a length of the first segment between the first end and the handgrip arrangement.

### BRIEF DESCRIPTION OF THE DRAWING

These and still other objects of my invention will become apparent from the preferred embodiment, which illustrates but does not limit my invention as shown in the drawing, wherein:

FIG. 1 is a perspective view that is partly broken away;

FIG. 2 is a front elevational view thereof;

FIG. 3 is a side elevational view thereof, the opposite side elevational view being a mirror image and, therefore, not shown; and

FIG. 4 is a rear elevational view thereof.

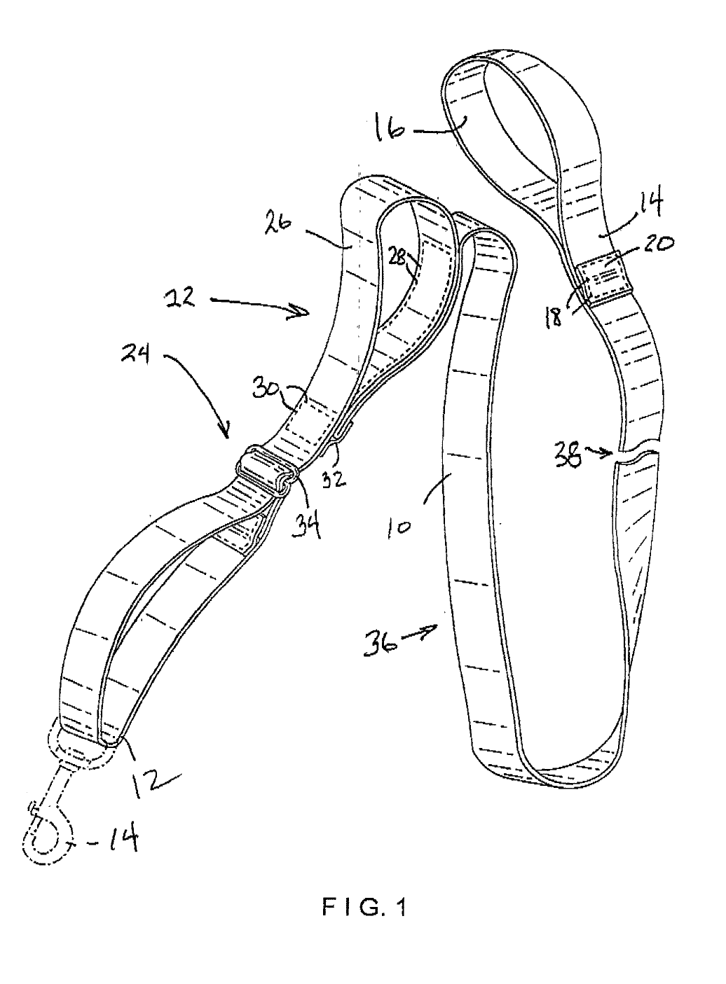

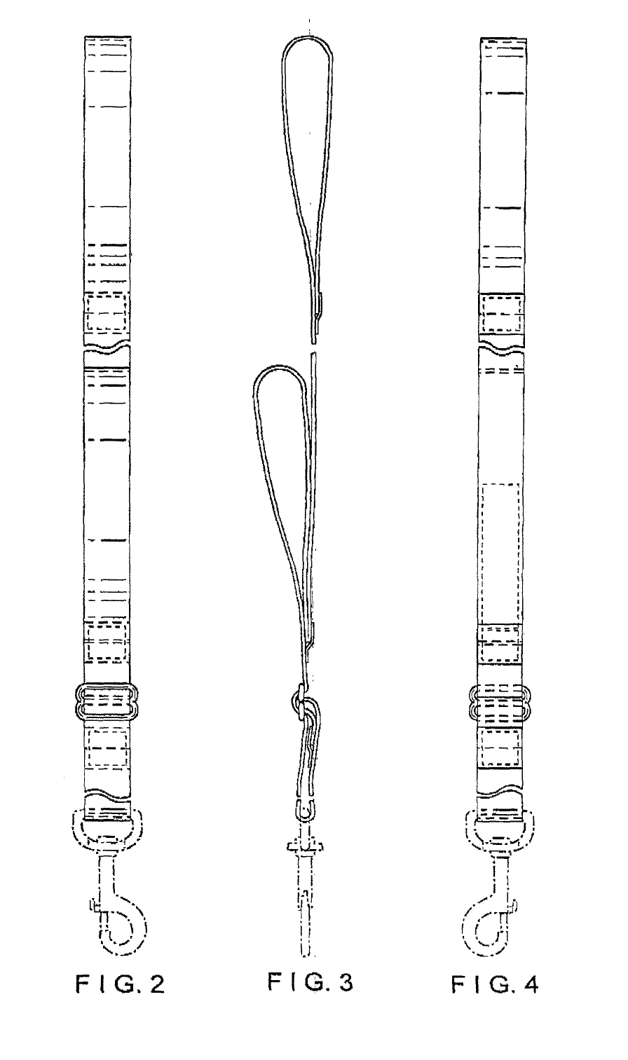

### DESCRIPTION OF THE PREFERRED EMBODIMENT

In the FIGS., the preferred embodiment is seen to be an elongated member 10 of flexible, web material. However, in other embodiments (not shown), equivalents of the member 10 can be formed by releasable or fixed interconnections of shorter lengths of the material. The flexible material may also be elastic or even plastic (non-memory elongatable material), in which case descriptions herein of longer and shorter lengths refer to the unstretched condition of the material. The web shape of the material may also be round, square or intermediate shapes in cross section, whereby to comprehend chains, wires, stranded and braided ropes and other flexible materials. The material may be of woven or non-woven fiber, leather, metal, plastic or other substances alone or in combination.

The member 10 has a first end 12 for connection to a mobile object, such as a dog, for example. For such connection, the first end 12 may be fitted with a snaffel hook 14 or any other known loop, hook or clasp devices, but those of ordinary skill will also recognize as equivalent a mere end for knotting, wherefor the snaffel hook 14 is shown in dashed lines and disclaimed.

The member 10 also has a longitudinally opposite, second end 14. In the preferred embodiment, the second end is doubled over a portion of the member 10 and fastened to it to form a loop 16 for a handgrip, but those of ordinary skill will recognize as equivalent a wide variety of other separate or unitary handle structures as well as a mere end, which can also be used as a handgrip, i.e. a portion for gripping by a hand, or fastened or knotted to another object such as a person.

For fastening the second end 14 to the member 10, the preferred embodiment uses stitching 18 and a reinforcing and finishing panel 20, which may or may not be of the same material as the member 10. However, those of ordinary skill will recognize as equivalent a wide variety of other fasteners, which include glue and adhesive as used herein, and fastening structures and arrangements, such as knots, for example.

Another handgrip at 22 is defined intermediate the first and second ends of the member 10, whereby to define a first segment at 24 of the member 10 between the first end 12 and handgrip definition at 22. In the preferred embodiment the handgrip is defined at 22 by doubling back a portion of the member to into a loop 26. The loop 26 is fixed on the member 10 by elongated and end stitching patterns 28 and 30 and a reinforcing or finishing panel 32. Although such sturdy construction is preferred, those of ordinary skill will recognize as equivalent other ways of defining the handgrip at 22, including mere marking, for example, other ways of forming the loop 26 and other handgrip structures (not shown) in unitary or assembled components with the member 10, and other ways of fixing these at least as described above and their equivalents.

The length of the first segment at 24 between the first end 12 and the handgrip definition at 22 is adjustable. For this in the preferred embodiment, the member 10 has been fed under, over and under successive first, second and third bars of a structure 34, doubled back from the first end 12 and connected to the second bar of the structure 34. This arrangement of the preferred embodiment is best seen in FIG. 3. The stitching and reinforcing or finishing panel arrangement for the connection to the second bar is similar to those already described and their equivalents.

Those of ordinary skill will know of many other ways of making a segment of adjustable length, including telescoping, nut/screw, buckle, coiling, inserting, knotting and the like, all of which are equivalent to the preferred embodiment shown in the drawing. Therefore, in particular, the shape and style of the structure 34 shown in the drawing will be understood to be representative only of the shapes and styles known to those of ordinary skill and considered equivalent herein.

The definition of the first segment at 24 by the handgrip definition at 22 inherently defines a second segment at 36 from the handgrip definition at 22 to the second end 14 of the member 10, whereby to make up the whole member. The second segment at 36 of the preferred embodiment is longer than the first segment at 24 even when the length of the first segment is adjusted to its maximum.

A portion at 38 of the second segment at 36 is cut away in the Figs. This indicates the indefinite length of the second segment, but also accommodates an arrangement or device of any known kind (not shown) that makes the length of the second segment adjustable. Such arrangement or device does not compromise the relative shorter and longer lengths of the first and second segments.

Still other variations, combinations and permutations are possible as will occur to those or ordinary skill and are contemplated as equivalents within the scope of my invention defined by the following claims:

I claim:

1. A leash comprising:
an elongated member having first and second opposite ends, whereby the second end can be used as a handgrip;
handgrip means intermediate the ends defining a handgrip location, whereby to define a portion of the elongated member between the first end and the handgrip means;
means for adjusting the length of the portion of the elongated member; and
means for connecting the first end to an object.

2. The leash according to claim 1, wherein the handgrip means divides the elongated member into longer and shorter segments, the shorter segment having the adjustable portion.

3. The leash according to claim 1, wherein the handgrip means further comprise means for joining the longer and shorter segments of the elongated member.

4. A leash, comprising:
elongated and flexible means for defining first and second longitudinally opposite ends, whereby the first end is connectable to a mobile object and the second end usable as a handgrip;
handgrip means intermediate the ends for defining a handgrip, whereby to define a first segment of the elongated and flexible means between the first end and the handgrip means; and
means for adjusting a length of the first segment.

5. The leash according to claim 4, and further comprising means dividing the elongated and flexible means into the first segment and a second segment extending to the second end, the first segment being shorted than the second segment.

6. The leash according to claim 5, wherein the means dividing the elongated and flexible means comprises the handgrip means.

7. The leash according to claim 5, and further comprising means for fixedly joining the first and second segments.

8. The leash according to claim 6, and further comprising means for fixedly joining the first and second segments.

9. The leash according to claim 7, wherein the means for fixedly joining the first and second segments comprises the handgrip means.

10. The leash according to claim 8, wherein the means for fixedly joining the first and second segments comprises the handgrip means.

11. A leash, comprising:
an elongated and flexible member having first and second longitudinally opposite ends, whereby the first end is connectable to a mobile object and the second end is usable as a handgrip;
a handgrip intermediate the ends, whereby to define a first segment of the elongated and flexible member between the first end and the handgrip and a second segment of the elongated and flexible member between the handgrip and the second end; and
means for adjusting a length of the first segment.

12. The leash according to claim 11, wherein the first segment is shorter than the second segment.

13. The leash according to claim 11, and further comprising a handgrip on the second end.

14. The leash according to claim 12, and further comprising a handgrip on the second end.

15. The leash according to claim 11, wherein the means comprises a structure having first, second and third bars for receiving the elongated and flexible member thereunder, thereover and thereunder, a portion of the elongated and flexible member at the first end being connected to the second bar.

16. The leash according to claim 12, wherein the means comprises a structure having first, second and third bars for receiving the elongated and flexible member thereunder, thereover and thereunder, a portion of the elongated and flexible member at the first end being connected to the second bar.

17. The leash according to claim 13, wherein the means comprises a structure having first, second and third bars for receiving the elongated and flexible member thereunder, thereover and thereunder, a portion of the elongated and flexible member at the first end being connected to the second bar.

18. The leash according to claim 14, wherein the means comprises a structure having first, second and third bars for receiving the elongated and flexible member thereunder, thereover and thereunder, a portion of the elongated and flexible member at the first end being connected to the second bar.

19. The leash according to claim 11, wherein the handgrip is a loop portion of the elongated and flexible member.

20. The leash according to claim 18, wherein the handgrip is a loop portion of the elongated and flexible member.
